(19) United States
(12) Patent Application Publication
(10) Pub. No.: US 2012/0039482 A1
(43) Pub. Date: Feb. 16, 2012

(54) HEADSET

(76) Inventor: Duncan Christopher Walsh, Nottingham (GB)

(21) Appl. No.: 13/262,792

(22) PCT Filed: Mar. 30, 2010
(86) PCT No.: PCT/GB10/00600

§ 371 Date: Oct. 3, 2011

(30) Foreign Application Priority Data
Apr. 2, 2009 (GB) 0905702.7

(51) Int. Cl. H04R 1/10

(52) U.S. Cl. 381/74

(57) ABSTRACT

A headset (1) including a loudspeaker (2, 3) associated with a housing (4). The housing (4) is arranged to be essentially waterproof or at least water resistant whereby an electronic device (9) within the housing (4) is essentially isolated in terms of a physical barrier to prevent water ingress. The device (9) is operated through a wireless connection, and powered by a battery (10) charged by an induction coil means whereby during charging, the housing (4) remains physically closed.

The present invention relates to headsets and more particularly to headsets which incorporate MP3 and/or at least receiver technology for voice messaging.

Recent capabilities with regard to electronic devices has enabled MP3 and other compressed data technology to be utilised for storage of hitherto unachievable volumes of data, particularly in the form of music, in a small device. Such devices can then be carried conveniently to enable a user to keep close at hand an almost full range of their music collection and tastes. Such easy access is a particular benefit with regard to lifestyle and in particular reduces the necessity of any impingement upon that lifestyle. In such circumstances portability with regard to the device is important.

Many people undertake exercise during which either sweat is produced, and/or that involves water as a constituent such as swimming or watersports such as sailing. Thus concerns must be addressed to the potential problems of water ingress to electronic devices. Although MP3 and other data compression technology as well as radio receivers can be incorporated within devices, impingement of water will rapidly deteriorate and damage or even destroy such electronic devices. With regard to sporting activity, provision of a device which is essentially a headset or headphones would be beneficial. The headset can be plugged into both or one of a user's ears, whilst also having the necessary electronics for the MP3 player and/or receiver built into it. The headset should also be rendered waterproof.

With regard to sporting activities, clearly training is also important. Provision of a device in the form of a headset which would allow and facilitate such training would be beneficial. Ideally the communication should be two way but it will be understood that such two way communication may result in further problems with the need for a microphone. It will also be understood there is limited availability with regard to bandwidth and therefore limited access to individual radio communication frequencies for dedicated links between a coach and a particular student/athlete.

In accordance with aspects of the present invention there is provided a headset comprising at least one earpiece associated with a housing, which housing provides a moisture resistant compartment for an electronic device, the device comprising at least one loudspeaker and a wireless receiver for receiving an external source of signals, the compartment being essentially physically closed once the housing is assembled to facilitate the moisture resistance, operation of the electronic device being through the wireless connection, a battery for the electronic device and a charging means for the battery being located within the compartment, the charging means being associated with an external surface of the housing, and/or by induction to a coil within the compartment, such that during charging the compartment remains physically closed.

The wireless receiver may be compatible with Bluetooth or a similar wireless connection protocol.

Generally, the electronic device is a personal digital apparatus or PDA in the form of a mobile phone or similar device. Generally, the electronic device includes a MP3 player.

The housing may have more than one separate moisture resistant compartment. Possibly, one or more of the separate compartments are for the loudspeaker or for further loudspeakers.

Typically, the housing has a gasket engageable between component parts to provide moisture resistance. Parts of the housing engageable against a gasket may be ribbed. The gasket may be ribbed, and may be ribbed on opposite sides.

Possibly, the housing has a sheath. The sheath may be flexible. Typically, switches are provided beneath the sheath, which can be operated therethrough.

Possibly, the housing incorporates external charging points as part of the charging means for the battery. Possibly, the charging means includes a coil for induction charging of the battery within the housing. Possibly, the coil is configured to allow data transfer by modulation of a charging frequency presented to the coil externally.

Generally, the electronic device may be potted in a potting material to prevent moisture ingress to the electronic device. Typically, the potting material is a plastic or wax.

Possibly, the housing is made of a flexible material. Possibly, the housing is transparent or semi transparent at least in part, to allow light transmission therethrough. Possibly, the electronic device includes light emitting diodes (LED) for wireless communication and/or indication functions.

Generally, the wireless receiver provides connection to an external device for voice communication to the electronic device. Typically, the electronic device is arranged to facilitate communication with the external device within a predetermined distance. Typically, the predetermined distance is between 20 and 300 metres. Generally, the electronic device is arranged to facilitate acceptance of connection with the external device.

Possibly, the electronic device is fragmented such that part of the electronic device is located permanently within the housing, whilst a further part is assembled with the housing in use. Typically, the further part comprises a SIM card or a mobile phone associated with the headset and within the containment. Generally connection between the further part and the remainder of the electronic device is through electrical induction or wireless connection.

Possibly, the headset includes or is associated with a microphone.

Possibly, the microphone includes a wireless link to the electronic device.

Aspects of the present invention will now be described by way of example with reference to the accompanying drawings in which:

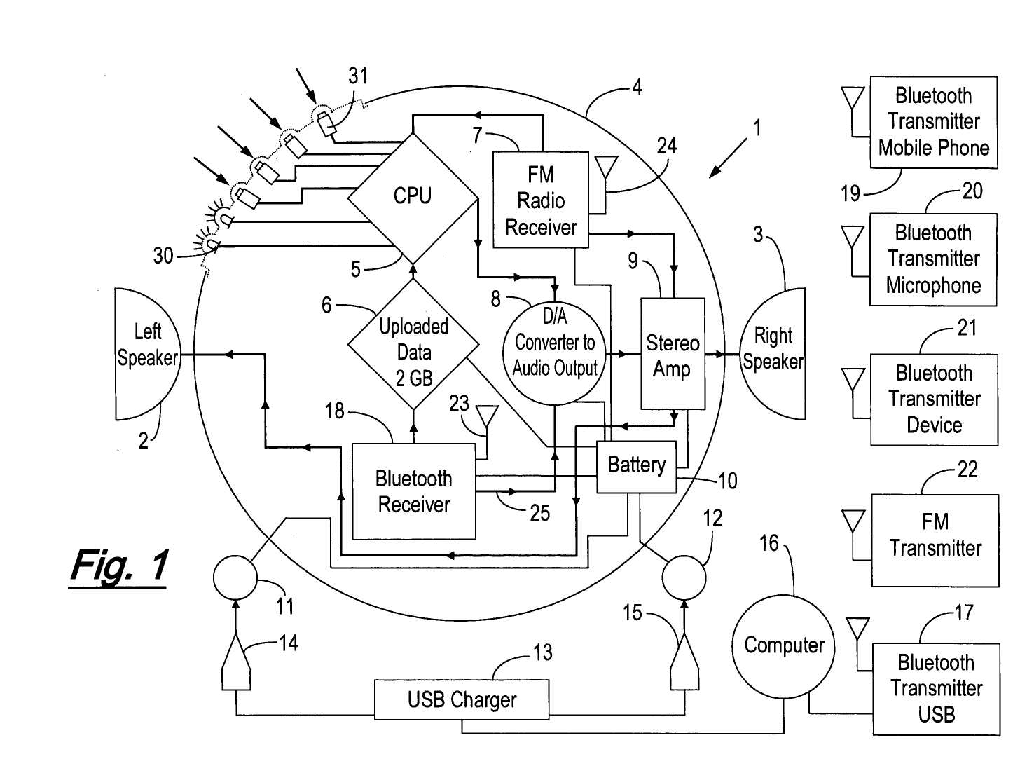

FIG. 1 is a schematic illustration of a headset in accordance with aspects of the present invention;

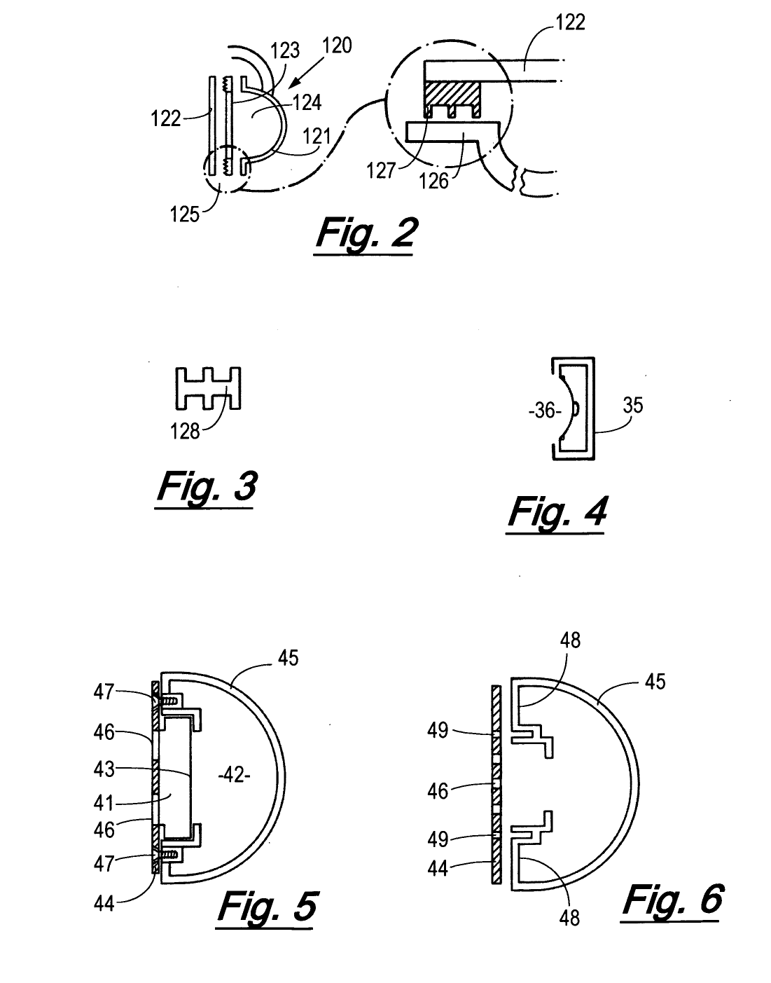

FIG. 2 is a schematic illustration of various seal elements utilised in accordance with aspects of the present invention;

FIG. 3 is a side view of a seal element utilised in accordance with aspects of the present invention;

FIG. 4 is a schematic cross section of a sheath utilised in accordance with aspects of the present invention;

FIG. 5 is a schematic cross section of a sheath mounted in accordance with aspects of the present invention;

FIG. 6 is a schematic cross section of parts of the sheath illustrated in FIG. 4;

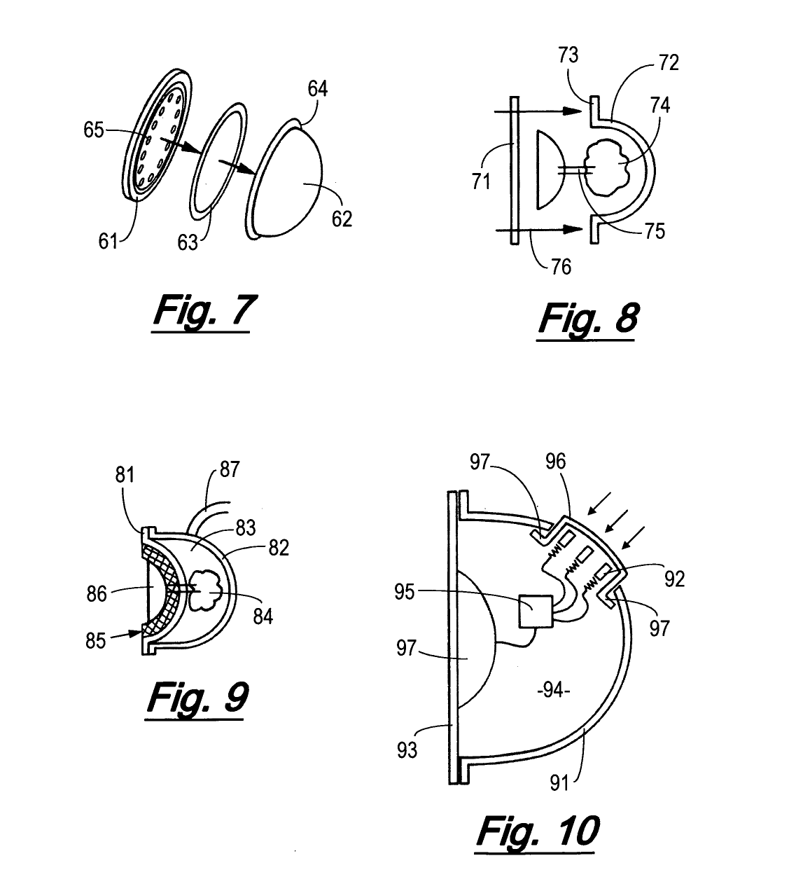

FIG. 7 is a exploded perspective view of a sealing arrangement utilised in a headset in accordance with aspects of the present invention;

FIG. 8 is a schematic cross section of a headset in accordance with aspects of the present invention including potting material for the electronic device;

FIG. 9 is a schematic illustration of an alternative potting arrangement utilisation with regard to a headset in accordance with aspects of the present invention;

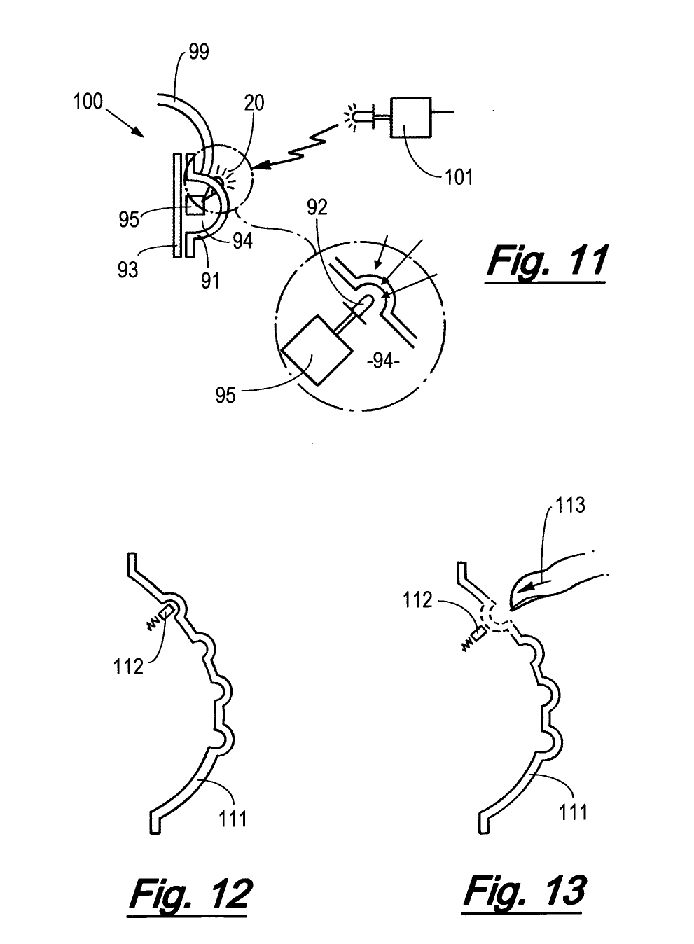

FIG. 10 is a schematic cross section of a headset in accordance with aspects of the present invention illustrating wireless connection;

FIG. 11 is a schematic illustration of an alternative wireless connection in accordance with aspects of the present invention;

FIG. 12 is a schematic cross section of a further sheath utilised in accordance with aspects of the present invention; and

FIG. 13 illustrates operation of the sheath of FIG. 12.

As indicated above, provision of a personal digital apparatus (PDA) which can be utilised particularly during sporting activities such as swimming or when a user will sweat profusely, creates difficulties. The sweat or water would ingress to the electronic device providing the MP3 function. More particularly with regard to sporting activities there are benefits with regard to at least comments from a coach to a student or athlete during training procedures.

It will be understood that it is possible to waterproof a mobile phone but certain elements such as the microphone and loudspeaker apertures are generally open and therefore provide moisture access pathways to the electronic equipment. Clearly, electronic equipment which is corrupted by moisture or water will no longer function.

It will also be understood with regard to sporting activities that ideally the actual sporting activity itself should be impeded as little as possible by the device. Consequently ideally a headset will be worn by a user incorporating the electronic device and allowing recall of music downloads or preferably as indicated for coaching purposes communication with a coach through an external remote device.

FIG. 1 provides a schematic illustration of a headset 1 in accordance with aspects of the present invention. Thus, the headset 1 comprises generally a left and a right earpiece or loudspeaker 2, 3 associated through a wire, or possibly a wireless link to a housing 4. The housing 4 is arranged to be essentially waterproof or at least water resistant, whereby the content of the housing 4 in the form of an electronic device is essentially isolated in terms of a physical barrier all about, to prevent water ingress.

The electronic device comprises a central processor unit 5 connected to a data store 6. The central processor unit 5 is also associated with a radio receiver 7 and a digital to analogue converter 8. In such circumstances the central processor unit 5 can receive signals through the radio receiver 7 or from the data store 6. The central processing unit 5 will then present additional signals to the converter 8 whereby analogue output is presented to a stereo amplifier 9 in order to provide output to the earpieces 2, 3.

It will be appreciated that as illustrated generally two earpieces 2, 3 are utilised, but in some circumstances a single earpiece 2, 3 may be used to ensure that a user in such circumstances maintains local awareness through environmental noise levels and understanding. Within the housing 4 generally a battery 10 is also provided in order to provide electrical power to the electronic device. It will be appreciated that the radio receiver 7 is optional and is a conventional feature.

In terms of operation in accordance with aspects of the present invention, the headset 4 must provide a water resistant barrier for the electronic device provided within the housing 4. Such maintenance of water resistance must allow charging of the battery 10 whilst also in accordance with aspects of the present invention allow control of the electronic device from an external device.

With regard to charging, as illustrated in FIG. 1 external charging points 11, 12 may be provided. These external charging points 11, 12 are surface mounted generally upon an external surface of the housing 4 with a waterproof or water resistant association. In such circumstances a charger 13, which may be of a USB type, can be associated with the points 11, 12 through elements 14, 15 in order to charge the battery 10.

Such charging may be controlled through a computer 16 which in turn may have its own wireless connection transmitter 17 for controlling connection with the electronic device provided within the housing 4. Thus through an internal battery check (not shown) to the battery 10, the computer 16 can be arranged to operate the charger 13 until the battery 10 is adequately charged. It will also be understood through the frequency and modulation of the electrical power provided through the points 14, 15 by the charger 13, that this frequency may be utilised for downloading data to the electronic device within the housing 4.

In the above circumstances powering of the electronic device through the battery 10 can be maintained through charging of the battery 10 as required. A further feature of aspects of the present invention is controlling the electronic device externally. This is achieved through a wireless connection. The wireless connection is typically of a Bluetooth or similar protocol, although as described later light pulse communication may also be utilised where appropriate. In such circumstances a wireless connection receiver 18 is provided.

The receiver 18 as indicated is of a wireless connection type and in such circumstances a similar wireless external device such as a mobile phone 19, transmitter microphone 20, transmitter device 21 or similar can communicate with the receiver 18 in order to control the electronic device within the housing 4. As indicated previously a standard radio FM transmitter 22 can also communicate with the FM radio receiver 7 where required. The benefit with regard to the receiver 18 is that mobile phone calls as well as coaching can be achieved and controlled through the communication link provided by the receiver 18. In order to facilitate connection by the receiver 18, generally an aerial 23 is provided within the housing 4 which is separate from an aerial 24 for the standard radio receiver 7.

Through use of a wireless connection such as a Bluetooth protocol receiver 18 it will be understood that the electronic device within the housing 4 may receive control signals as well as other information which is initially stored in the memory 6, and then utilised by the central processor unit 5 in order to provide signals through the converter 8 and amp 9 to the earpiece loadspeakers 2, 3. The Bluetooth receiver in such circumstances which will be of a low band rate, will allow buffering of information in the memory 6 prior to utilisation by the CPU 5. Thus the data compression protocols of an MP3 player can be utilised both for initial transmission purposes as well as storage within the store 6 through the interface of the receiver 18.

The memory 6 in such circumstances may store music as described above or coaching instructions for a user to be played appropriately. The receiver 18 may also override the CPU 5 in terms of access through a link 25 directly to the converter 8 in order that direct communication through one of the devices 19 to 21 or 17 such that the coach can provide specific instructions as required to a student or athlete to improve their particular performance at that time, or enable the coach in such circumstances through the receiver 18 to stimulate an appropriate message package from the store 6 through the CPU 5 to the converter 8. Thus the coach can then reiterate a particular coaching sequence from what has been seen at a particular time rather than reiterate the entire message again through the direct link 25 avoiding problems with interruption with the link.

In the above circumstances an electronic device in accordance with aspects of the present invention as indicated is substantially isolated from its environment by the housing 4 providing a moisture resistant containment. Within this moisture resistant containment the electronic device can operate and is controlled through a wireless connection. The wireless connection allows the electronic device to work in a number of functions. Firstly, the activated device can simply under the stimulus of a user download messages or music tracks, and the electronic device can receive instructions and control signals through the receiver 18 or further messages or music downloads provided through the link 18 as required. Finally the link 18 allows specific messaging such as a mobile phone voice link(s) to be created or to a coach through an appropriate remote device to provide specific instructions necessary at that time.

Through the receiver 18 it will be understood that the headset 1 will enable the Bluetooth protocol or similar protocol to accept connection to a device 19 to 21 or 17, or not. In such circumstances specific links to an individual or groups of users can be achieved in accordance with aspects of the present invention.

A further alternative is to provide LEDs 30 or light devices 31 to enable wireless connection through light signals. In such circumstances all users of a device may be accessed at the same time through the light signals. Thus with regard to operation for instance within a noisy factory environment, the light sensors 31 may be sensitive to changes in the light within that environment. Thus when the light changes, the sensors 31 will notice that light change and the CPU 5 will be configured to retrieve an appropriate message from the memory 6. This message may indicate that a forklift truck or other dangerous device or procedure is being performed within a near vicinity of the user with the headset and that message then presented through the earpieces 2, 3. Alternatively in a social situation such as with regard to a nightclub the light changes received by the sensor 31 may be translated into pulsations with regard to music presented to the speakers 2, 3 for an amusing effect.

It will be understood with regard to conventional wireless communication, transmission requires relatively large power outputs. Such power outputs are to provide a range which may not be necessary with regard to devices in accordance with aspects of the present invention. In such circumstances LEDs 30 are utilised to provide a signalling process. These LEDs 30 will illuminate in a particular sequence or continuously to indicate status or requirement for assistance. In such circumstances with regard to a coaching environment, illumination of the LEDs 30 may indicate to the coach that a user requires assistance and therefore through the receiver 18 that coaching is provided. The coaching may be through voice messaging as indicated or through the coach having viewed the user, then indicating the correct message to be presented through the CPU and converter 8 as retrieved from the memory 6.

It will be understood in the above circumstances by a combination of the wireless connection, either presented through the Bluetooth or similar protocol receiver 18 and/or light communication processing created through the sensors 31 and LEDs 30 along with power connection through points 11, 12, the housing 4 essentially isolates the electronic device within the housing 4 in use. In such circumstances provided an adequate seal can be created between parts of the housing moisture ingress to the electronic device is avoided.

It will be understood that reduction in the number of apertures and access pathways for moisture access to the internal parts of the housing 4 eliminates the prospect of moisture ingress damaging the electronic device. The speakers 2, 3 can be associated as indicated through a wireless connection themselves (not shown) or through electrical wires which themselves pass through the housing 4 through an appropriate water resistant gland or otherwise. The electrical wires can be easily sealed and therefore can be readily made water resistant.

Similarly, the points 11, 12 although convenient to provide charging through the charger 13 and elements 14, 15 may also be securely and externally mounted with an appropriate water resistant seal. Alternatively, within the housing 4 an electrical induction coil can be utilised for electrical induction charging of the battery 10 in use. Such an approach will eliminate the points 11, 12 and therefore again reduce the number of potential apertures and moisture ingress pathways into the housing 4 in use.

It will be appreciated that appropriate water resistant sealing is generally utilised in accordance with aspects of the present invention. Thus, as illustrated in FIG. 2 a headset in accordance with aspects of the present invention will typically incorporate a housing 120 formed by a shell 121 with a face plate 122 in order to create when assembled an enclosure which has substantial moisture resistance to an inner cavity 124. The shell 121 and faceplate 122 may be substantially solid and in such circumstances it is the junction 125 between the shell 121 and the plate 122 which must provide an adequate seal.

In the embodiment depicted in FIG. 2, such sealing is achieved through a gasket 123. The gasket 123 generally has a ribbed structure such that the ribs of the structure extend from the plate 122 towards a flange part 126 of the shell 121 in order to create a seal. The gasket 123 as indicated has ribs 127 which are compressed by the association across the plate 122 to the flange 126 to create a seal. Alternatively as illustrated in FIG. 3, a double ribbed gasket 128 may be created whereby ribs extend in opposite directions towards the plate 122 (not shown) and the flange 126 (not shown) to create sealing effects.

FIG. 4 illustrates an alternative or more normally an additional process for creating water resistant containment of a housing in accordance with aspects of the present invention. Thus in addition to the sealing created through gaskets 23 as described above, a sheath 35 is presented over an earpiece 36. The sheath 35 as described later with regard to FIGS. 5 and 6 is secured appropriately to create a moisture resistant containment for electronic devices and earpiece elements such as loudspeakers in accordance with aspects of the present invention.

It will be appreciated that the sheath 35 is generally flexible in order to provide appropriate containment, but could also be a solid substantially rigid structure dependent upon requirements. In either event, the sheath 35 must be secured to the earpiece or loudspeaker 36, and it is again this means of location and securing which will determine the sealing effect and therefore prevention of moisture entering into the containment provided. Moisture resistance is important, and therefore care must be taken with regard to the containment provided by the sheath in accordance with aspects of the present invention.

FIG. 5 illustrates one alternative with regard to creating a moisture resistant containment in accordance with aspects of the present invention. It will be understood that with regard to loudspeakers it is necessary to provide generally a space for the acoustic effects of the loudspeaker to be effective. With regard to a water resistant containment, it will be understood that generally such spaces are an anathema. By aspects of the present invention as illustrated in FIG. 5, a space 41 can be created whereby a loudspeaker either independently or as part of an electronic device located within an enclosure 42, can operate in order to provide acoustic effects.

Essentially, within the enclosure 42 electronic devices or the loudspeaker are secured with a gasket or lining 43 to define a space 41. Generally a face plate 44 is created and secured to a sheath 35. The face plate 44 generally includes apertures 46 whereby the acoustic waves created within the space 41 are presented to a user. The sheath 45 essentially creates a confinement 42 within which the electronic device or more typically in the embodiment depicted in FIG. 5 a loudspeaker, is secured. The loudspeaker in such circumstances can act through the gasket or lining 43 upon the space 41 which is offset from the face plate 44. In such circumstances the space 41 allows the acoustic effects of the loudspeaker to be operative to a user.

The sheath 42 is generally secured to the face plate 44 through screws 47. The plate 44 and or the sheath 45 at least with regard to flange parts (FIG. 2), are generally formed from elastomeric and flexible material. In such circumstances the compressive effect created by the screws 44 will create a seal at the flat to flat abutment between the plate 44 and the flange parts of the sheath 45. Thus apart from the apertures 46, the containment 42 is essentially isolated and moisture resistant, but the lining 43 to the space 41 resists moisture passage through the apertures 46.

FIG. 6 illustrates the principal parts of the sheath 45 and face plate 44 utilised in accordance with aspects of the present invention. Generally, the sheath 45 as indicated is flexible such that the face plate 44 may be rigid. The plate 44 will incorporate apertures 46 as described above for acoustic transmission to a user. Further apertures 49 will present means for securing the plate 44 to the sheath 45 through flange portions 48. The flange portions 48 themselves will include recesses for receipt of the screws 47 (not shown), and therefore securing of the sheath 45 to the plate 44. The sheath 45 itself will typically incorporate necessary constructions for creating the space 41 (FIG. 5) within which the acoustic effects can be generated. A liner 43 (FIG. 5) will be located between the plate 44 and structured within the sheath 45, for presentation and lining of the space 41 as described above.

In order to further avoid moisture ingress it will be appreciated that the confinement created by the sheath 44 may be pressurised in that a positive pressure is created which will force out moisture rather than ingress of moisture to the containment 42 (FIG. 5). Further alternatively, within the plate and/or the flange 48 a one way valve structure may be created such that the flexibility of the sheath 45 will allow compression of the sheath 45 to expel any air within the containment 42 through that one way valve initially, and subsequently to enable such expelled air to evacuate the space 41 where required. In such circumstances the sheath 45 may be slightly larger than necessary for the electronic device in accordance with aspects of the present invention.

FIG. 7 illustrates a typical assembly for a headset in accordance with aspects of the present invention. Thus, a face plate 61 is associated with a cover 62 with an appropriate seal 63 between. The components are assembled in the direction of the arrowhead whereby the face plate 61 is generally in a compressive abutment with flange parts 64 of the cover 62. The seal 63 as indicated above may incorporate ribs, but as illustrated in FIG. 7 may also comprise an O ring seal located in an appropriate recess between the plate 61 and the flange 64. The O ring will typically be under partial pressurisation to create an appropriate seal for the cover 62. The plate 61 as illustrated will typically incorporate apertures 65 of a relatively small size to avoid moisture ingress. These apertures 65 may be covered by a membrane in any event. Once assembled an appropriate containment for moisture resistance as indicated above is created.

Maintenance of an essentially moisture free environment within the containment created by a housing in accordance with aspects of the present invention is the principal means for continued operation of the headset. The electronic device in such circumstances, assuming electrical power is provided by the battery, can be controlled by the external connection through the wireless connection as indicated above.

A further alternative is to effectively pot, that is to say encase the electronic device in an appropriate potting material. FIGS. 8 and 9 illustrate processes with regard to creating a headset within which the electronic device is potted in accordance with aspects of the present invention. As illustrated in FIG. 8, as previously a face plate 71 is presented in an appropriate assembly with a closure or cover 72 in order that a containment is created for an electronic device.

In accordance with the embodiment depicted in FIG. 8 the electronic device is potted, that is to say dipped and encased within a potting material 74 such that any moisture that does become ingressed within the headset does not present upon sensitive parts of the electronic device. Wires 75 in the embodiment extend to a loudspeaker 76. As indicated previously waterproofing and water resistance of wires 75 is more readily achieved than with regard to the electronic device itself or the speaker 76. The speaker 76 in such circumstances will be appropriately protected or as illustrated in FIG. 9 the speaker itself presented within potting material.

In FIG. 9 as previously, a housing is created by a cover or closure 82 associated with a face plate 81 through an appropriate seal and flange portions. Within a containment 83 created within the housing between the cover 82 and the face plate 81, electronic equipment and an electronic device are potted within the potting material 84. In addition in the embodiment depicted in FIG. 9, a loudspeaker itself is also presented in potting material 85.

In such circumstances the potting material 85 will line the loudspeaker and in particular the armature portions to prevent ingress of moisture and therefore provide moisture resistance to the loudspeaker and the containment. Diaphragm portions in the loudspeaker 85 will still operate in order to provide acoustic effects but as indicated moisture ingress inhibiting operation of the headpiece will be avoided. Typically as illustrated in FIG. 9, a head band 87 will be associated with the housing 85 to allow operation and location of the headpiece about a user's head in use.

The potting material utilised with regard to the electronic device and/or the loudspeaker portions will typically be of a plastics or wax material type. In such circumstances the electronic device or loudspeaker portions can be embedded within the potable material to prevent moisture gaining access to sensitive parts of the electronic device or loudspeaker.

Generally, the housing in accordance with aspects of the present invention will be utilised with electronic devices in order to achieve contactless and essentially isolated operation. In such circumstances as illustrated in FIG. 10, a cover or sheath 91 may be transparent or semi transparent such that light emitting diodes or light sensitive elements 92 can operate. The cover 91 will be associated with a face plate 93 in order to create a containment 94 for an electronic device 95. The electronic device 95 will be associated with the light emitting diodes or sensors 92 in order that interaction can be achieved.

This interaction may be simply through indicative light signals showing the status of the headpiece, or alternatively may be utilised for wireless communication through light flashes etc. In such circumstances the cover 91 may be substantially rigid whilst the sheath portion 96 may be flexible or rigid itself, such that at least an appropriate moisture resistant seal is created between opposed flange portions 97 between the sheath 96 and the cover 91. In such circumstances the containment 94 in terms of moisture resistance remains intact to protect the electronic device 95. The electronic device 95 itself will be secured and associated with a loudspeaker 98 such that through face plate 93 an appropriate acoustic response can be achieved.

FIG. 11 provides an illustration of operation of a headpiece in accordance with aspects of the present invention based upon light beam flashes etc. Thus, a headpiece 100 as described previously comprises a face plate 93 and a cover 91 with an electronic device 95 within a containment 94 formed by the housing comprising the plate 93 and the cover 91. As described previously typically a headband 99 will allow the head piece 100 to be secured to a user during operation.

In terms of communication through a wireless connection as indicated, light emitting diodes and/or sensors 92 will be located within the containment 94 whereby an external device in the form of a light emitting source 101 can provide light signals to the electronic device 91 through the LEDs/sensors 92 within the containment 94. In such circumstances by appropriate light signal sequencing or simple light operation of the right frequency, operation of the headpiece 100 can occur.

In an exploded portion it will be noted that the sensor or light emitting diode 92 is located within an appropriate portion of the cover 91 or sheath 92 whereby light transmission can occur through that sheath or cover. In such circumstances it will be understood that the sheath or cover will be formed from a transparent or semi transparent material to allow light ingress. Nevertheless, a physical barrier is created to provide moisture resistance to the containment 94 and therefore protect the electronic device 95 in operation.

The “light” wireless communication between the handset and the external “coach” device may be utilised to authorise a Bluetooth or similar protocol link. Thus, if a headset wishes to communicate with an external source the LEDs will be illuminated or vice versa. In such circumstances, there will be acceptance of a Bluetooth link.

It will be appreciated that generally in addition to control provided through the wireless communication link, direct controls for the headpiece will be necessary. These controls may be simply an on off switch, controls to enable alteration of noise levels or to confirm a Bluetooth link etc. In such circumstances as illustrated in FIGS. 12 and 13, parts of the housing and in particular the cover or sheath may be flexible. As illustrated in FIGS. 12 and 13 a sheath or cover 111 will incorporate appropriate recesses and protrusions to accommodate switches 112.

Thus, as illustrated in FIG. 13 where the sheath 111 is flexible, it will be understood that by pressing the protrusion using a force in the direction of arrowhead 113 by a user, the switch 112 is operated. The switch 112 will be associated with the electronic device in order to provide a control function as illustrated. This control function as described above may be with regard to a simple on off switch, or more functional in terms of volume control for the audio output or other feature. It will be understood that the switch 112 may be associated with a light emitting diode to facilitate location within the sheath 111.

By aspects of the present invention charging can occur without breaking the essential moisture resistant barrier created by the housing. In such circumstances either through charging pins or through electrical induction to a coil for battery, charging which would breach the housing barrier can be avoided. Such avoiding of apertures and openings will reduce the possibility for water paths and moisture paths into the containment defined by the housing in accordance with aspects of the present invention. Lack of apertures and holes through the housing will also once assembled create an essentially closed containment which need not be breached for charging or uploading of data to or control of the electronic device.

Generally, the wireless connection in accordance with aspects of the present invention will be of a Bluetooth or similar protocol and in such circumstances the device will have compatibility with a wide range of PDA and mobile phone devices. Where necessary for data transfer external pins again appropriately located within the housing may be utilised but such data transfer pins will be on the surface and therefore can be made part of the water resistant barrier. Generally, an appropriate seal in the form of a rib is created about parts of the housing in order to create the confinement. In addition potting material can be utilised within the containment to further prevent ingress of moisture.

By creating a sheath or part of the housing which is flexible, it will be understood that an appropriate water resistant barrier can be achieved. By utilisation of a sheath particularly with regard to earpiece loudspeakers, those which are of an ordinary over the ear type can be utilised through the seal created by the sheath.

Through an appropriate wireless connection as indicated above, a wide range of devices can be associated with the headset including TV, microphone, mobile phone, computer, routers or music devices. Differentiation between these devices may be through a handshake type access protocol defined by LED light/light sensor links between the headset and the device.

By utilisation of gaskets and sheaths it will be understood that problems with regard to accurate assembly are avoided. The gaskets and sheaths will create the necessary seals and therefore reduce production difficulties and quality control problems. Where necessary by encapsulating or potting the electronic device a further barrier to moisture entry to the electronic device is provided. The electronic device as well as the loudspeaker or parts of the loudspeaker may be embedded within an appropriate potting material where desirable.

In addition to external device communication, it will be understood that the wireless communication connection in accordance with aspects of the present invention may be utilised with regard to other headsets. In such circumstances where light emitting diodes and sensors are utilised for the wireless connection it will be understood that two or more users of headsets in accordance with aspects of the present invention may communicate through the light signals from the headsets or be grouped by a common light signal colour or sequence for Bluetooth or other protocol communication.

Thus, with respect to swimmers, should those swimmers come within a certain distance of each other then the light emitting diodes and sensors in each headset may be raised to communicate in order to avoid collision. It will also be understood where the headsets are utilised with regard to swimming, a light signal may be provided to indicate that the swimmer must leave the pool or a particular group of swimmers may receive common coaching messages.

Modifications and alterations to aspects of the present invention will be appreciated by persons skilled in the technology. In such circumstances as indicated above, parts of the housing may be flexible to allow evacuation or to create positive pressure for resistance of water ingress whilst other parts are of a more rigid nature. Furthermore, the housing may be arranged to accommodate in a water resistant manner a user's own mobile phone such that through a Bluetooth connection between that mobile phone and other parts of the electronic device operation of the headset can be achieved.

In such circumstances the electronic device in accordance with aspects of the present invention comprises parts permanently located within the assembled headset and the inserted mobile phone or other device. The mobile phone will depend upon its connection protocol which may be of a Bluetooth nature to communicate with the embedded permanently assembled parts of the electronic device. In such a manner the stored data within the mobile phone or MP3 player or other device can be utilised within the headset in accordance with aspects of the present invention.

Furthermore, messages received whilst wearing the headset may be downloaded to the user's normal mobile phone and vice versa. Possibly, the headset includes a microphone. Normally, the microphone will be waterproof and/or may be associated with the electronic device by a wireless link to reduce compromise to the housing barrier used to inhibit moisture ingress. Alternately, a bleep device may be provided to indicate a message, text or audio, has been received. Typically, as indicated the headphones or set will include a music player (MP3) so that means will be provided to skip recorded tracks forwards and/or backwards individually or a set number of tracks eg 10. Thus, review of the available tracks may be more convenient.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A headset comprising at least one earpiece associated with a housing, which housing provides a moisture resistant compartment for an electronic device, the device comprising at least one loudspeaker and a wireless receiver for receiving an external source of signals, the compartment being essentially physically closed once the housing is assembled to facilitate the moisture resistance, operation of the electronic device being through the wireless connection, a battery for the electronic device and a charging means for the battery being located within the compartment, the charging means being associated with an external surface of the housing, and/or by induction to a coil within the compartment, such that during charging the compartment remains physically closed.

2. A headset according to claim 1, characterised in that the wireless receiver is compatible with Bluetooth or a similar wireless connection protocol.

3. A headset according to claim 1, characterised in that the electronic device is a personal digital apparatus or PDA in the form of a mobile phone or similar device.

4. A headset according to claim 1, characterised in that the electronic device includes a MP3 player.

5. A headset according to claim 1, characterised in that the housing has more than one separate moisture resistant compartment.

6. A headset according to claim 5, characterised in that one or more of the separate compartments are for the loudspeaker or for further loudspeakers.

7. A headset according to claim 1, characterised in that the housing has a gasket engageable between component parts to provide moisture resistance.

8. A headset according to claim 7, characterised in that parts of the housing engageable against a gasket may be ribbed.

9. A headset according to claim 7, characterised in that the gasket is ribbed.

10. A headset according to claim 9, characterised in that the gasket is ribbed on opposite sides.

11. A headset according to claim 1, characterised in that the housing has a sheath.

12. A headset according to claim 11, characterised in that the sheath is flexible.

13. A headset according to claim 12, characterised in that switches are provided beneath the sheath, which can be operated therethrough.

14. A headset according to claim 1, characterised in that the housing incorporates external charging points as part of the charging means for the battery.

15. A headset according to claim 1, characterised in that the charging means includes a coil for induction charging of the battery within the housing.

16. A headset according to claim 15, characterised in that the coil is configured to allow data transfer by modulation of a charging frequency presented to the coil externally.

17. A headset according to claim 1, characterised in that the electronic device is potted in a potting material to prevent moisture ingress to the electronic device.

18. A headset according to claim 17, characterised in that the potting material is a plastic or wax.

19. A headset according to claim 1, characterised in that the housing is made of a flexible material.

20. A headset according to claim 1, characterised in that the housing is transparent or semi transparent at least in part, to allow light transmission therethrough.

21-31. (canceled)
